(19) United States
(12) Patent Application Publication
(10) Pub. No.: US 2002/0082999 A1
(43) Pub. Date: Jun. 27, 2002

(54) Method of preventing reduction of sales amount of records due to digital music file illegally distributed through communication network

(76) Inventors: Cheol-Woong Lee, Seoul (KR); Chang-Young Lee, Seoul (KR)

Correspondence Address: ABELMAN FRAYNE & SCHWAB, Attorneys at Law, 150 East 42nd Street, New York, NY, 10017, US

(21) Appl. No.: 09/977,895

(22) Filed: Oct. 15, 2001

(30) Foreign Application Priority Data
Oct. 19, 2000 (KR) 2000-61622

(51) Int. Cl. G06F 17/60; H04K 1/00; H04L 9/00

(52) U.S. Cl. 705/51

(57) ABSTRACT

A method of preventing reduction of sales amount of records due to a digital music file illegally distributed through a communication network is disclosed. The method comprises the steps of a)producing an advertising digital music file by deteriorating or damaging a sound quality of an original music file of a record of a cooperating record corporation; and b)distributing the advertising digital music file through the communication network. The present invention provides a method of producing a digital music file with lower sound quality for publicity, and distributing it over the network before a formal record is sold, thus minimizing a distribution of the illegal digital music file with the same quality as the original music file on the network.

### BACKGROUND OF THE INVENTION

1. Field of the Invention

The present invention relates in general to a method of preventing reduction of sales amount of records due to a digital music file illegally distributed through a communication network, and more particularly to a method which distributes a digital music file with low or damaged sound quality through the network, and induces a user listening to the digital music file on the network to purchase a record, thus preventing reduction of sales amount of records.

2. Description of the Prior Art

Generally, a record corporation sells a record produced by recording an analog or digital signal on a medium such as a cassette tape or an optical disc (e.g. long play disc or compact disc).

As digital audio-concerned techniques have been developed, many softwares and hardware devices have been developed for forming an analog or digital signal recorded onto a medium as a digital-format music file such that it can be stored or copied easily with a digital device (e.g. personal computer terminal), and freely reproduced from the device.

The digital-format music file generated by the softwares or hardware devices is easily propagated through a communication network due to its characteristic of simplicity in reproducing and transmitting. Especially, a digital music file with MP3 (MPEG1 layer 3) format, which recently has gained great popularity, has a data size smaller than that of a conventional digital music file by 90 to 92%, while its sound quality is as high as an original sound recorded in the medium (for example, compact disc) by using an audio compression technique of MPEG 1. For this reason, a large quantity of digital music files with MP3 format have been illegally reproduced through the communication network.

Moreover, many programs or services such as “Napster” or “Soribada” for sharing digital music files with data format such as MP3 between different users using a P2P (peer to peer) method have been proposed and popularized among users recently. Thus, a search and reproduction of the digital music file through the communication network are gradually becoming easier and more simplified, and thus the users of the programs or the services are progressively increased in number.

However, the conventional digital music file is disadvantageous in that the reproduction of the digital music file illegally infringes a copyright of the music, and thereby, sales amounts of formal records have been reduced.

Recently, a record corporation or an affiliated company produces a digital music file, inserts an encryption key, a reproduction preventing code, or water mark code in the produced music file for preventing a reproduction or an use without permission, and sells the music file with the key or code on the communication network. The record corporation or the cooperation company prohibits a sharing service such as “Napster” from sharing the digital music file, which is illegally produced or reproduced, by taking legal actions.

However, this method is unuseful in that the hackers can easily crack the encryption key, the reproduction preventing code or the watermark code. Further, a recent service program such as a “Gnutella” for directly connecting the users on the network like a web of a spider without a separate agent server has been developed. Thereby, due to such service programs, it is more difficult to restrain users from sharing the digital music file through the network by legal means. The service program such as “Napster” or “Soribada” searches for each user's digital music file through the agent server, and connects the users to each other, and then, it is possible to take a legal action against a service provider managing the agent server. However, the service program connecting the users without the agent server, like a “Gnutella” has no entity for taking a legal action against.

As shown above, the conventional method of inserting a specific code in the digital music file or encrypting the music file, and method of restraining a distribution of the music file by compulsory means are problematic in that it is difficult to substantially prevent a direct sharing of the music files between the users and an illegal reproduction on the communication network.

### SUMMARY OF THE INVENTION

Therefore, the present invention has been made in view of the above problem, and it is an object of the present invention to provide a method of preventing reduction of sales amount of records due to a digital music file illegally distributed through the communication network, by distributing the digital music files with low or damaged sound quality on the network in place of restraining an illegal reproduction and distribution, and using the distributed music files only for “Pre-Listening”.

In accordance with one aspect of the present invention, the above and other objects can be accomplished by the provision of a method of preventing reduction of sales amount of records due to a digital music file illegally distributed through a communication network, comprising the steps of a)producing an advertising digital music file by deteriorating or damaging a sound quality of an original music file of a record of a cooperating record corporation; and b)distributing the advertising digital music file through the communication network.

In accordance with another aspect of the present invention, there is provided a method of preventing reduction of sales amount of records due to a digital music file illegally distributed through a communication network, comprising the steps of: a)collecting an illegally produced digital music file, which is derived from a record of a cooperating record corporation by searching the communication network; b)editing the collected digital music file to deteriorate or damage the sound quality of it; and c)distributing the edited digital music file through the communication network again.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a system for performing a method of preventing reduction of sales amount of records according to the present invention;

FIG. 2 is a flowchart showing a method of preventing reduction of sales amount of records due to a digital music file illegally distributed through a communication network according to preferred embodiment of this invention;

FIGS. 3 through 6 are views of examples showing a generation and editing of a digital music file using a well-known software tool of this invention;

FIG. 7 is a flowchart showing a method according to another preferred embodiment of this invention; and

FIG. 8 and FIG. 9 are views showing a search for illegally produced digital music file using a well-known music file sharing program.

### DETAILED DESCRIPTION OF THE PREFERRED EMBODIMENTS

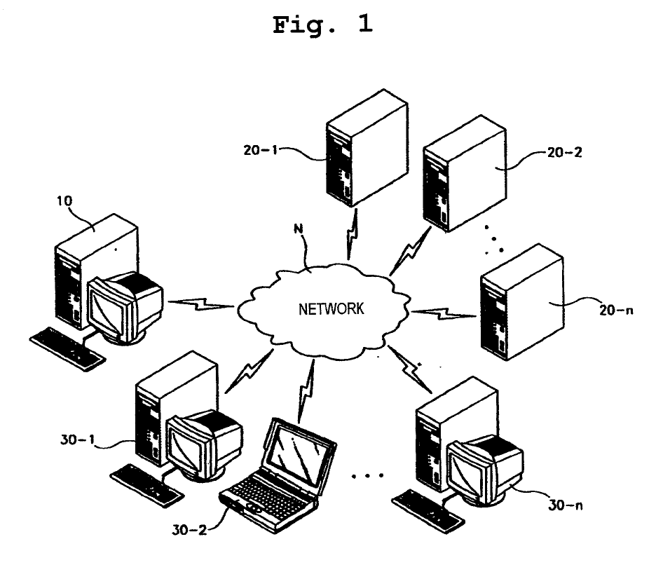

FIG. 1 is a block diagram showing a system for performing a method of preventing reduction of sales amount of records due to a digital music file illegally distributed through the communication network. Referring to FIG. 1, the system comprises a searching and editing terminal 10, music file sharing servers 20-1˜20-n, music file user terminals 30-1˜30-n, and a network N. The terminals 10, 30-1˜30-n and the servers 20-1˜20-n are commonly connected to the network N such as an Internet through various well-known devices like a modem or router, and various methods. The construction and operation of the terminals 10, 30-1˜30-n and the servers 20-1˜20-n is well known in the field and further explanation is thus not deemed necessary.

The searching and editing terminal 10 produces an advertising digital music file of a cooperating record corporation, distributes the advertising music file through the network N or searches for an illegally produced digital music file which is shared or distributed over the network, and collects and edits the searched music file.

The searching and editing terminal 10 includes a general hardware device(not shown) included in a computer system, such as a main processor, a network adapter, a display adapter, a main memory and an auxiliary memory, and an operating system(OS) and a program tool for extracting an original sound from a record and converting it into a digital music file, and a program tool for editing the digital music file. The specific construction and operation of the terminal 10 is well known in the field and further explanation is thus not deemed necessary.

Further, various music file sharing programs which are generally used through the communication network are installed at the searching and editing terminal 10 in order to search for the digital music files shared or distributed through the network N.

The music file sharing servers 20-1˜20-n search another user's terminal connected to the network N for a corresponding digital music file according to requests from the music file user terminals 30-1˜30-n, and connect the user terminals 30-1˜30-n so as to enable the users to share the digital music files with each other.

The music file user servers 30-1˜30-n operate to share the digital music files through the network N and exchange them through the user terminals 30-1˜30-n. The music file user servers 30-1˜30-n include general hardware devices(not shown) installed in a computer system, such as a main processor, a network adapter, a display adapter, a main memory and an auxiliary memory, and an operating system(OS) and at least one of music file sharing programs for sharing the music files between users through the network N.

Hereinafter, an operation sample of the present invention having the construction above will be described in detail.

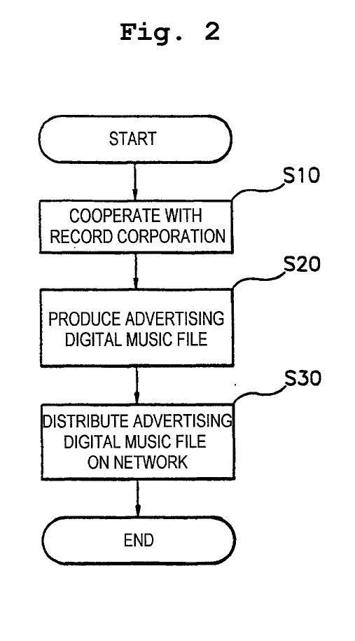

FIG. 2 is a flowchart showing a method of preventing reduction of sales amount of records due to a digital music file illegally distributed through a communication network of this invention.

Referring to FIG. 2, a service provider for producing the advertising digital music files and distributing them, cooperates with a corresponding record corporation, and makes a service contract with the record corporation for preventing the distribution of the illegally produced(or reproduced) digital music files derived from a record of the record corporation at step S10.

Then, the service provider produces an advertising digital music file using a well-known encoding program or music file-editing program at step S20.

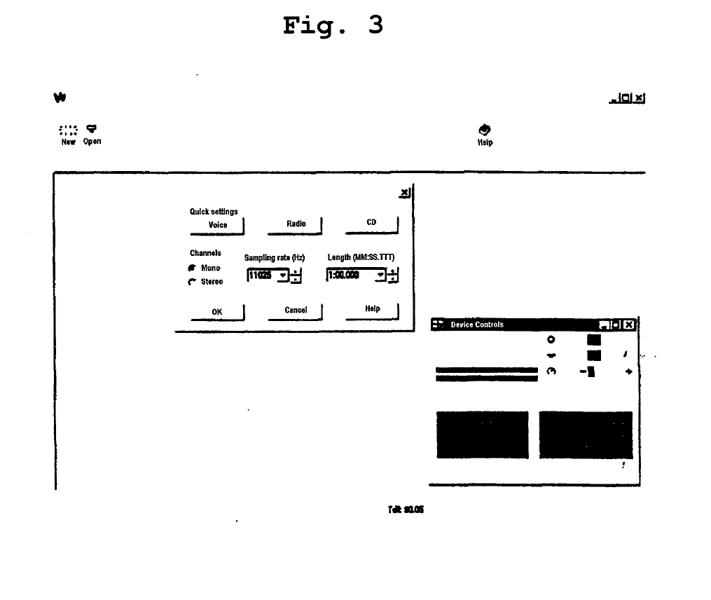

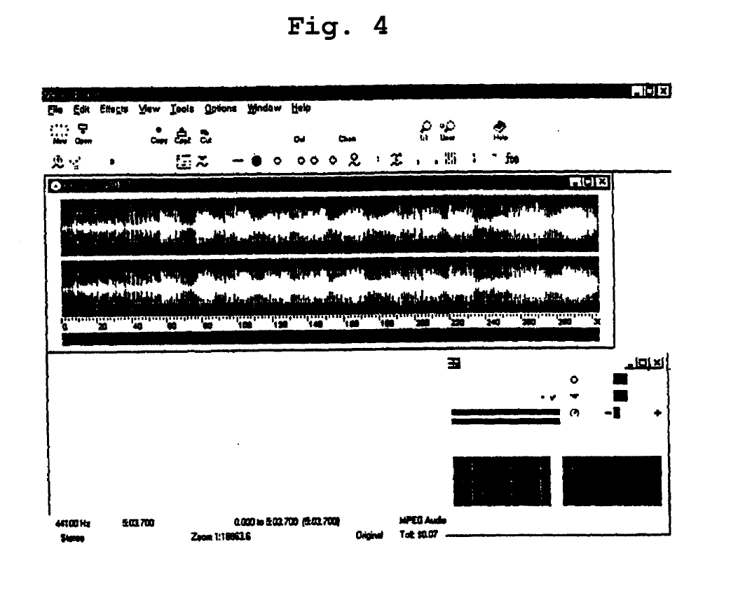

As an example, a process for producing the advertising digital music file is shown in FIG. 3 and FIG. 4. Referring to FIGS. 3 and 4, a wave file is extracted from a source record(e.g. tape or compact disc) using a program tool of “Gold Wave” produced by the programmer “Chris Craig”, and then the extracted wave file is converted into a digital music file with a MP3 format.

As stated above, the digital music file generated by conversion of the wave file is compulsorily deteriorated or damaged in its sound quality by any means, such that it decreases the user's desire to listen and keep the music file, thus inducing the user listening it to purchase the formal record according to his or her preference.

For example, a method of deteriorating or damaging the digital music file in sound quality may include the functions of 1)inserting noise component such as a voice for publicity of a singer or performer in the music, 2)lowering a sampling rate of the digital music file to below that of an original music(typically, digital file with MP3 format has a sampling rate of 44.1 KHz) 3)distorting a waveform of the music file, and 4)converting a multi-channel sound of the music file to a single-channel sound.

The various functions of deteriorating or damaging the sound quality of the music file are supported by the most of well-known music file editing program tools, thus editing the digital music files without difficulty by using the editing program tools.

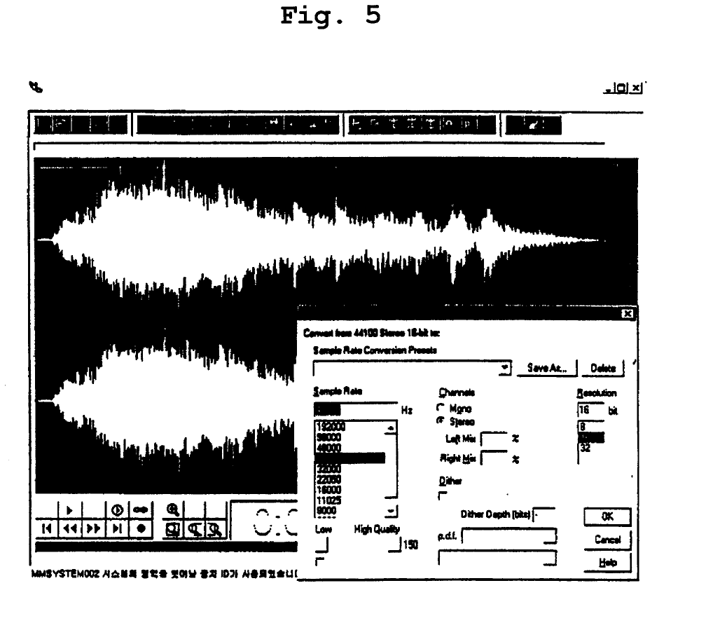

As an example, using the program tool of “Gold Wave”, and “Cool Edit” produced by a “Syntrillium Software Corporation” as shown in FIG. 5, it is possible to insert the noise such as a voice of the singer in the music file and in addition, easily adjust the sampling rate of the music file during a generation of the digital music from the record, and easily change the sampling rate of the generated music file. Generally, if the music is sampled with a lower sampling rate, fidelity of the sound is lowered compared with the original sound, and then the user can recognize easily a deterioration of the sound quality.

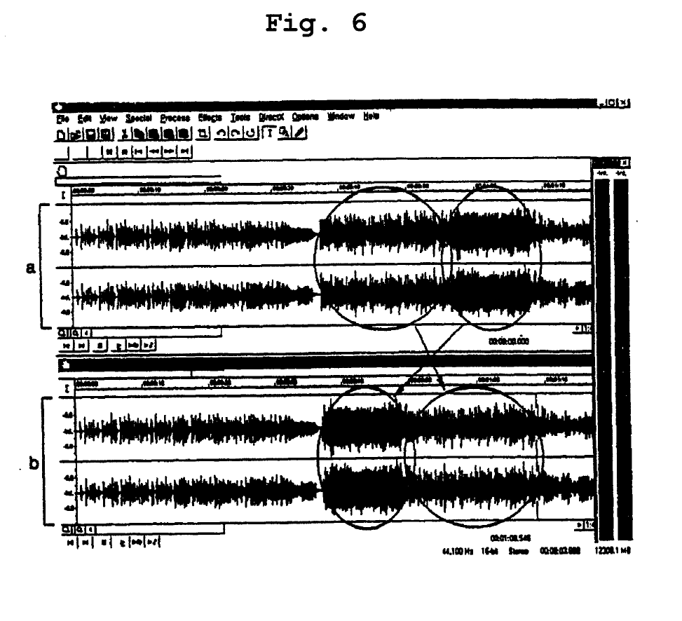

As an another example, the digital music file is easily edited by using a program tool “Sound Forge” produced by the corporation “Sonic Foundry INC” as shown in FIG. 6 as well as “Gold Wave” and “Cool Edit”. Referring to the example of FIG. 6, the music file is edited by using a function of a “Cut” and “Paste” and modifying a position of the waveform of the original music file. In FIG. 6, “a” is a waveform of the original music file and “b” is an edited waveform thereof.

As described above, if the sound waveform of the music file is edited, the user can recognize a difference between the edited sound and the original sound, and then cannot be satisfied with the edited sound.

Further, the music file can be easily converted from multi-channel sound(e.g. stereo sound of two-channel) into a single-channel sound(e.g. mono sound) by the music file editing program tool. If the multi-channel sound is converted into the single-channel sound, realism of the sound is remarkably reduced, and sounds between each musical instrument are not distinguished well, thus lowering the sound quality of the music.

Referring to FIG. 2 again, the advertising digital music file damaged by above methods is distributed over the network N by sharing or another method at step S30.

For example, the damaged advertising music file can be distributed to many users by sharing it on the network N using a popular music file sharing program(e.g. “Napster” or “Soribada”).

Preferably, the distribution of the advertising digital music file is achieved before a formal record is sold on the market or the communication network. When the formal record starts to be sold, the illegally produced digital music files, which are generated using the music file encoding program, are already shared between the users on the network N. Then, by flooding the network by distributing the advertising digital music file before the illegally produced music file is available, the user can search for only the advertising music file, not the illegally produced music file with the same sound quality to the original music file, thus preventing the distribution of the illegally produced digital music file through the network.

However, sometimes during a producing of a record, a demo-tape or etc. is smuggled and, then the illegally produced digital music file can be shared through the network N before the formal record is sold. Further, providing that the distribution of the illegally produced music file is prevented by cooperating with a service provider after the record corporation releases the record for sale, a large quantity of the illegal music files are already distributed on the network N.

In this case, according to another preferred embodiment as described below, the digital music file already distributed on the network N is collected and damaged, and then distributed on the network N again, thus preventing the reduction of sales amount of the records due to the illegally reproduced digital music file.

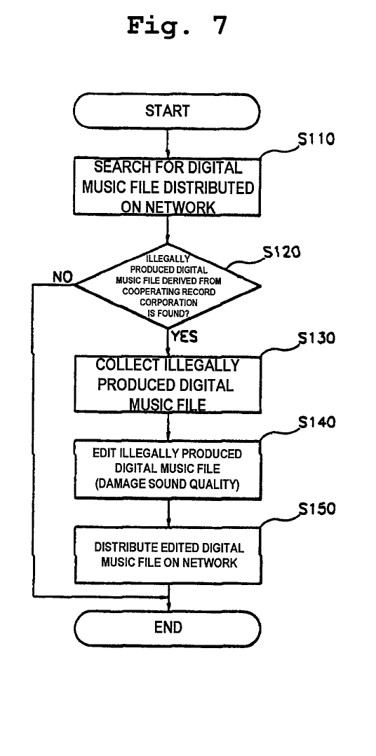

Hereinafter, another preferred embodiment of this invention will be described in detail referring to FIG. 7 through FIG. 9

FIG. 7 is a flowchart showing a method according to another preferred embodiment of this invention.

First, a plurality of the digital music files distributed on the network N are searched for by a searching and editing terminal 10 connected to the network N at step S110. At this time, the searched digital music file is the music file derived from a record of the cooperating record corporation, and the digital music file can be searched by a generally used file sharing program. Preferably, the sharing program has a relatively high recognition degree among the users and wide popularization, and is used to search for the music file.

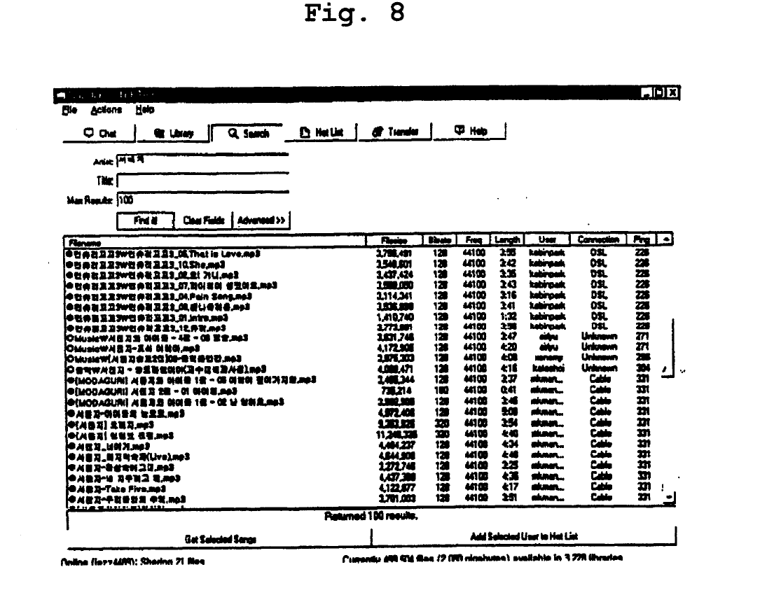

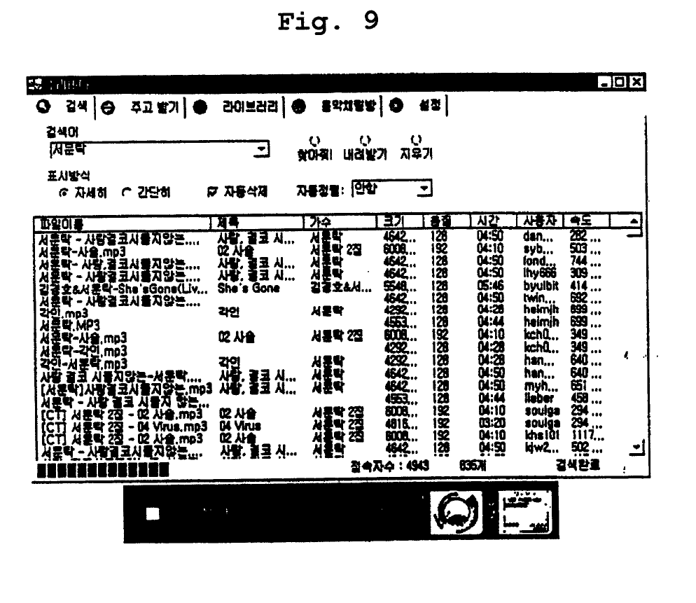

As an example, FIG. 8 and FIG. 9 are views displaying searching for the music file shared on the network N by the widely popularized music file programs such as “Napster” or “Soribada”.

If the illegally produced music file derived from the record of the cooperating record corporation is found at step S120 according to the searching result at step S110, the found digital music file is collected according to the kinds of music at step S130. Generally, one digital music file per a piece of music is collected. However, if necessary, a plurality of music files per a piece of music can be collected.

According to the kinds of music, if only some part of the music files shared on the network N are collected, it is preferable to collect one among the shared music files in which many copies of the same file have the same name, size and playing time. The greater the numbers of the music file with a same name, size and playing time, the higher probability of its being reproduced later by another user, due to its wide distribution through the network to many users.

Referring to FIG. 7 again, the collected music file is edited to deteriorate or damage its sound quality at step S140. At this time, a method to deteriorate or damage the digital music file in sound quality may include the functions of 1) inserting noise component such as voice for publicity of a singer or performer in the music using a well-known music file editing program tool, 2)lowering a sampling rate of the collected digital music file than that of the original music 3)distorting a waveform of the music file, and 4)converting a multi-channel sound of the music file into a single-channel sound.

In this case, preferably, the edited music file is edited to have the same file name, file size and playing time as those of the collected music file.

Next, the damaged or deteriorated music file by editing is distributed over the network N again at S150. To distribute the edited music file over the network N, a popular music file sharing program(e.g. “Napster” or “Soribada”) is used, thus sharing the music file with the normal users equally as shown at step S30 of FIG. 3.

As described above, when the edited digital music file is shared on the network N, an illegally produced music file containing an original sound quality is distributed along with the edited digital music file. Through the above process, the music file users listen to the edited digital music file, such that it decreases the reliability of the illegal music file on the network N and then induces a distrust of the sound quality of the illegal music file by the users, thus stimulating the users to purchase the formal record.

The digital music files generated or edited by the present invention have a very low sound quality compared with the original music, and thus, preferably, it can be used only for “Pre-listening” on the network rather than possessing it like a record. So the user having listened to the music file on the network is induced to purchase the formal record if he prefers it, thus achieving an essential function of publicity. In other words, an illegally produced music file according to the prior art encroaches the record market, while the present invention can promote the record market by propagating new music with the distributed music file.

As described above, only the case of sharing and searching the digital music file, which is generated and edited for publicity through the agent server such as “Napster” or “Soribada” is described, but the present invention is not restricted. Further, a program for sharing and searching the digital music file by directly connecting between the users using the P2P without the agent server such as “Gnutella” can be applied to the present invention. It also should be noted that the present invention could be easily applied to a case of downloading a digital music file through a web site.

As apparent from the above description, the present invention provides a method of producing a digital music file with lower sound quality for publicity, and distributing it over the network before a formal record is sold, thus minimizing a distribution of the illegal digital music file with the same quality as the original music file on the network. Further, the advertising digital music file, which occupies the network first, has a very low sound quality compared with the original music and is generated only for “Pre-Listening”, thus preventing the reduction of sales amount of the record due to the illegally reproduced digital music file.

Further, the present invention collects the illegally produced(or reproduced) digital music file that is distributed over the network, damages the sound quality of the collected music file, and redistributes the damaged music file on the network, thus inducing a distrust of the sound quality and reliability of the illegal music file by the users, and stimulating the users to purchase the formal record.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preventing reduction of sales amount of records due to a digital music file illegally distributed through a communication network, comprising the steps of:
a)producing an advertising digital music file by deteriorating or damaging a sound quality of an original music file of a record of a cooperating record corporation; and
b)distributing the advertising digital music file through the communication network.

2. The method as set forth in claim 1, wherein at step a) the advertising digital music file is generated by inserting noise component such as a voice of a singer or performer in the original music file, thereby damaging the sound quality.

3. The method as set forth in claim 1, wherein at step a) the advertising digital music file is generated by lowering a sampling rate of the digital music file to below that of the original music file, thereby deteriorating the sound quality.

4. The method as set forth in claim 1, wherein at step a) the advertising digital music file is generated by distorting the waveform of the original music using a function such as a “cut”, “copy”, or etc., thereby damaging the sound quality.

5. The method as set forth in claim 1, wherein at step a) the advertising digital music file is generated by converting a multi-channel sound of the original music to a single-channel sound, thereby deteriorating the sound quality.

6. A method of preventing reduction of sales amount of records due to a digital music file illegally distributed through a communication network, comprising the steps of:
a)collecting an illegally produced digital music file, which is derived from a record of a cooperating record corporation by searching the communication network;
b)editing the collected digital music file to deteriorate or damage the sound quality of it; and
c)distributing the edited digital music file through the communication network again.

7. The method as set forth in claim 6 wherein at step a) the collected music file is edited by inserting noise component such as a voice of a singer or performer in the collected music file, thereby damaging the sound quality of the illegally produced music file.

8. The method as set forth in claim 6, wherein at step a) the collected music file is edited by lowering a sampling rate of the collected music file to below that of an original music file, thereby deteriorating the sound quality of the illegally produced music file.

9. The method as set forth in claim 6, wherein at step a) the collected music file is edited by distorting the waveform of the collected music using a function such as “cut”, “copy”, or etc., thereby damaging the sound quality of the illegally produced music file.

10. The method as set forth in claim 6, wherein at step a) the collected music file is edited by converting a multi-channel sound of the collected music file to a single-channel sound, thereby deteriorating the sound quality of the illegally produced music file.
